(19) United States
(12) Patent Application Publication
(10) Pub. No.: US 2012/0158389 A1
(43) Pub. Date: Jun. 21, 2012

(54) Method and System For Rapid Model Evaluation Using Multilevel Surrogates

(75) Inventors: Xiaohui Wu, Sugar Land, TX (US); Dachang Li, Katy, TX (US); Rossen Parashkevov, Houston, TX (US); Adam K. Usadi, Basking Ridge, NJ (US); Yahan Yang, Pearland, TX (US)

(73) Assignee: Exxonmobile Upstream Research Company, Houston, TX (US)

(21) Appl. No.: 13/392,035

(22) PCT Filed: Jul. 28, 2010
(86) PCT No.: PCT/US10/43499

§ 371 Date: Feb. 23, 2012

Related U.S. Application Data
(60) Provisional application No. 61/260,555, filed on Nov. 12, 2009.

(51) Int. Cl. G06G 7/48; G06F 15/18

(52) U.S. Cl. 703/10; 706/12

(57) ABSTRACT

The present techniques disclose methods and systems for rapidly evaluating multiple models using multilevel surrogates (for example, in two or more levels). These surrogates form a hierarchy in which surrogate accuracy increases with its level. At the highest level, the surrogate becomes an accurate model, which may be referred to as a full-physics model (FPM). The higher level surrogates may be used to efficiently train the low level surrogates (more specifically, the lowest level surrogate in most applications), reducing the amount of computing resources used. The low level surrogates are then used to evaluate the entire parameter space for various purposes, such as history matching, evaluating the performance of a hydrocarbon reservoir, and the like.

### CROSS REFERENCE TO RELATED APPLICATION

This application claims the benefit of U.S. Provisional Patent Application 61/260,555, filed Nov. 12, 2009, entitled Method and System for Rapid Model Evaluation Using Multilevel Surrogates, the entirety of which is incorporated by reference herein.

### FIELD

Exemplary embodiments of the present techniques relate to a method and system for characterizing the predictions of multiple computer simulation models. More specifically, the techniques decrease the number of full physics simulations that may be run to generate a model for predicting the properties of a hydrocarbon reservoir.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Many scientific and engineering applications require the evaluation of multiple models that are typically described by partial differential equations (PDEs), e.g., optimization, parameter identification, uncertainty analysis, among others. In these applications, the PDEs depend on a set of parameters varying within some predefined ranges and forming a parameter space. The space is N-dimensional if there are N independent parameters. Each point in the parameter space corresponds to a particular model. In optimization, multiple model evaluations are used to determine parameters that provide optimal model responses with respect to certain functions, e g , minimizing cost or maximizing profit in many business applications. In parameter identification, a subset of the parameter space is sought in order to match model responses with observations or other predefined functions. For uncertainty analysis, model responses often need to be evaluated over the entire parameter space. These applications are useful in the development and production of hydrocarbons from subsurface formations. These processes often simulated by using reservoir models that depend on many geologic and engineering parameters, some of which are uncertain.

In practice, solving PDEs to a high degree of accuracy is often time consuming, and it may be helpful to use fast surrogates or proxies to approximate model responses (see, for example, Queipo, N. V., Haftka, R. T., Shyy, W., Goel, T., Vaidyanathan, R., and Tucker, P. K., “Surrogate-based analysis and optimization,” Progress in Aerospace Sciences (2005), 41, 1-28). Data-fit surrogates, reduced order modeling, and reduced physics modeling have been used to accelerate the evaluation of multiple models. The fundamental challenge in surrogate-based model evaluations is that faster surrogates often require more training for them to appropriately approximate original model responses. Often, as the parameter space becomes large, the amount of surrogate training diminishes the benefit it brings to speed-up model evaluations.

To overcome this challenge, the use of multilevel approximations or variable-fidelity models has been proposed for solving optimization problems (see, for example, Alexandrov, N. M., Lewis, R. M., Gumbert, C. R., Green, L. L., and Newman, P. A., “Approximation and model management in aerodynamic optimization with variable-fidelity models,” J. Aircraft (2001), 38, 1093-1101; and Lewis, R. M. and Nash, S. G., “Model problems for the multigrid optimization of systems governed by differential equations,” SIAM. J. Sci. Comput. (2005), 26(6), 1811-1837). These gradient-based methods focus on finding the direction of steepest descent in the search for local optima. Because only certain paths in the parameter space are explored, these methods are not suitable for global optimization, uncertainty analysis, or global parameter identification (i.e., multiple disconnected subsets of parameter space are identified).

Derivative (or gradient) free methods based on direct searches have also been studied (see, for example, Audet, C. and Dennis, J. E., “Mesh adaptive direct search algorithms for constrained optimization,” SIAM J. Optim. (2006), 17(2), 188-217). These methods use surrogates to quickly search trial points for local optima in the parameter space. However, these methods are limited in their capacity to handle a large parameter space. No multilevel extension has been proposed.

In short, existing multilevel surrogate-based model evaluation methods are focused on local optimization problems. They do not evaluate the global response of models over the entire parameter space. On the other hand, surrogate-based uncertainty or global sensitivity analysis is performed with single-level, data-fit surrogates (for example, as described in Queipo, et al.), such as kriging or polynomial response surfaces generated using experimental design techniques, or other regression methods based on various machine learning techniques. Applicability of these methods is limited to relatively low dimensional parameter spaces, because the cost of training these surrogates grows exponentially with the parameter space dimension. Thus, there is no efficient method for generating global model responses over a relatively high (e.g., >10) dimensional parameter space as is often encountered in practice.

Further related information on creating surrogates may be found in: Wu, X. H., Stone, M. T., Parashkevov, R. R., Stern, D., Lyons, S. L., “Reservoir modeling with global scale-up,” SPE paper 105237 (2007); Aarnes, J. E., Hauge, V. L., and Efendiev, Y., “Coarsening of three-dimensional structured and unstructured grids for subsurface flow,” Advances in Water Resources (2007), 30(11), 2177-2193; Smolyak, S. A., “Quadrature and interpolation formulas for tensor products of certain classes of functions,” Dokl. Akad. Nauk SSSR (1963), 4, 240-243; Nobile, F., Tempone, R., and Webster, C. G., “A sparse grid stochastic collocation method for partial differential equations with random input data,” SIAM J. Numer. Anal. (2008), 46(5), 2309-2345; Gyulassy, A., Natarajan, A., Pascucci, V., and Hamann, B., “Efficient computation of Morse-Smale complexes for three-dimensional scalar functions,” IEEE Transactions on Visualization and Computer Graphics (2007), 13(6), 1440-1447; Lipnikov, K., Moulton, J. D., Svyatskiy, D., “A multilevel multiscale mimetic (M3) method for two-phase flows in porous media,” J. Comp. Phys (2008), 227(4), 6727-6753; and Couplet, M., Basdevant, C., and Sagaut, P., “Calibrated reduced-order POD-Galerkin system for fluid flow modeling,” J. Comp. Phys (2005), 192-220.

Therefore, techniques for more efficiently creating a surrogate in a parameter space would decrease the number of simulation runs used while retaining accuracy.

### SUMMARY

An exemplary embodiment of the present techniques provides a method for lowering computational costs of multiple simulations. The method includes identifying a lowest level training set (TS¹) in a lowest level physics based surrogate (PBM¹) and generating at least one higher level training set (TS^{k}) for at least one higher level PBM^{k}, wherein 1<k<K and wherein K represents a highest level surrogate. The method also includes training the at least one higher level PBM^{k} at TS^{k} using a next higher level physics based surrogate (PBM^{k|1}). As used herein, a superscript denotes models or point sets on a particular level of the hierarchy.

Identifying TS¹ may include sampling a parameter space to obtain a first set of sample points, evaluating a response for PBM¹ at each of the sample points, training a data fit surrogate (DFS¹) over the parameter space using the response at each of the sample points, and identifying a second set of sample points for the TS¹, wherein a response of the DFS¹ exhibits a critical behavior at the second set of sample points. The critical behavior may correspond to a local maximum, a local minimum, a saddle point, or a combination thereof

Generating the TS^{k} for the PBM^{k} may include evaluating PBM^{k} at lower level sample points in TS^{k-1}, and selecting a subset of the lower level sample points at which the difference between a response of PBM^{k} and PBM^{k-1} is relatively large, wherein the subset includes TS^{k}. Additional sample points may be added to TS^{k} based at least in part on an estimate of the distribution of the difference between PBM^{k} and PBM^{k-1} over the parameter space. At least one of the PBM^{k} may be a reduced physics model (RPM). In an exemplary embodiment, training the at least one higher level PBM^{k} may include estimating parameters of PBM^{k} given responses of PBM^{k+1} at TS^{k}, and tuning the coefficients to match the responses, for example, by adjusting the coefficients in the modeling equations to improve the match. In other embodiments, training the at least one higher level PBM^{k} may include modeling the differences between PBM^{k} and PBM^{k+1} at TS^{k} using a DFS.

In an exemplary embodiment, the method may further include repeating the steps for at least one additional iteration, or repeating the steps until a model response at the lowest level changes by less than about 5% between iterations.

In an exemplary embodiment, the method may include coarsening a full physics model by discretizing model equations on meshes with different resolutions. In other embodiments, the method may include performing a fine-grid discretization of model equations, and performing a mathematical multigrid operation to derive a coarse-grid discretization of the model equations. In yet other embodiments, the method may include coarsening a fine-scale reservoir model to a coarse scale reservoir model by solving a series of single-phase steady-state flow equations.

Another exemplary embodiment of the present techniques provides a method for producing hydrocarbons. The method includes generating a model based on hierarchical surrogates. Generating the hierarchical surrogates includes identifying a lowest level training set (TS¹) in a lowest level physics based surrogate (PBM¹), generating at least one higher level training set (TS^{k}) for at least one higher level PBM^{k}, wherein 1<k<K, and wherein K represents a highest level surrogate, and training the at least one higher level PBM^{k} at TS^{k} using a next higher level physics based surrogate (PBM^{k+1}). The method may also include predicting a performance parameter from the model.

The predicted performance parameter may be used to determine a location for a new well. Furthermore, a determination whether to convert an injection well into a production well, a production well into an injection well, or to convert multiple wells may be made at least in part upon the performance parameter predicted from the model.

A third exemplary embodiment of the present techniques provides a tangible, machine-readable medium, comprising code configured to direct a processor to identify a lowest level training set (TS¹) in a lowest level physics based surrogate (PBM¹), generate at least one higher level training set (TS^{k}) for at least one higher level PBM^{k}, wherein 1<k<K, and train the at least one higher level PBM^{k} at TS^{k} using a next higher level physics based surrogate (PBM^{k+1}).

The tangible, machine-readable medium may also include code configured to direct the processor to sample a parameter space to obtain a first set of sample points, evaluate a response for PBM¹ at each of the first set of sample points, and train a data fit surrogate (DFS¹) over the parameter space using the response at each of the first set of sample points. The code may also be configured to identify a second set of sample points for the TS¹, wherein a response of the DFS¹ exhibits a critical behavior at the second set of sample points.

The tangible, machine-readable medium may also include code configured to direct the processor to evaluate PBM^{k} at lower level sample points in TS^{k-1}, and select a subset of the lower level sample points at which the difference between a response of PBM^{k} and PBM^{k-1} is relatively large, wherein the subset comprises TS^{k}. Further, the tangible, machine-readable medium may include code configured to direct the processor to estimate parameters of PBM^{k} from responses of PBM^{k-1} at TS^{k}, and tune the parameters to match the responses.

### DESCRIPTION OF THE DRAWINGS

The advantages of the present techniques are better understood by referring to the following detailed description and the attached drawings, in which:

FIG. 1 is a diagram illustrating the use of multiple runs of a full physics simulation to train a data fit surrogate for a gas-to-oil ratio for a field;

FIG. 2 is a diagram of a hierarchical group of surrogates that may be created to more efficiently model a reservoir, in accordance with exemplary embodiments of the present techniques;

FIG. 3 is a block diagram of a method for using hierarchical surrogates in accordance with embodiments of the present techniques;

FIG. 4 is a diagram illustrating model coarsening to create two hierarchical levels of physics based surrogates, in accordance with exemplary embodiments of the present techniques;

FIG. 5 is a graph of an data fit surrogate (DFS⁰) trained from the PBM¹ of FIG. 4 in accordance with embodiments of the present techniques;

FIG. 6 is a graph illustrating the response of twenty sample points (TS¹) selected from DFS⁰ for further modeling in accordance with embodiments of the present techniques;

FIG. 7 is a graph illustrating the responses from PBM¹ for the points in TS¹, in accordance with embodiments of the present techniques;

FIG. 8 is a graph illustrating the responses at the eleven points of TS² in FPM³, in accordance with embodiments of the present techniques;

FIG. 9 is a graph illustrating the responses obtained from PBM² at the remaining nine points of TS¹ run after training of PBM² by the responses at TS² obtained from the FPM³, in accordance with embodiments of the present techniques;

FIG. 10 is a graph of the final DFS⁰ constructed after the eleven responses from TS² and the remaining responses are used to train the PBM¹, in accordance with embodiments of the present techniques; and

FIG. 11 illustrates an exemplary computer system on which software for performing processing operations of embodiments of the present techniques may be implemented.

### DETAILED DESCRIPTION

In the following detailed description section, the specific embodiments of the present techniques are described in connection with preferred embodiments. However, to the extent that the following description is specific to a particular embodiment or a particular use of the present techniques, this is intended to be for exemplary purposes only and simply provides a description of the exemplary embodiments. Accordingly, the present techniques are not limited to the specific embodiments described below, but rather, such techniques include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Adjoint model” or “adjoint method” refers to a mathematical evaluation of the sensitivity of a predictive model such as a process-based model. Moreover, an adjoint model provides sensitivity data that represents the extent to which the output of a predictive model varies as its input varies. An adjoint model may comprise computing the gradient or sensitivity of the acceptance criteria with respect to model parameters by solving an auxiliary set of equations, known as adjoint equations. The adjoint method is an efficient method for computing sensitivities of large-scale conditioning tasks and, unlike most methods, the computational cost does not scale with the number of conditioning parameters. Many types of adjoint models are known in the art.

“Coarsening” refers to reducing the number of cells in simulation models by making the cells larger, for example, representing a larger space in a reservoir. The process by which coarsening may be performed is referred to as “scale-up.” Coarsening is often used to lower the computational costs by decreasing the number of cells in a geologic model prior to generating or running simulation models.

“Computer-readable medium” or “tangible machine-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the techniques is considered to include a tangible storage medium or distribution medium and prior art-recognized equivalents and successor media, in which the software implementations of the present techniques are stored.

“Delaunay triangulation” refers to a triangulation of a set of points such that no point is within the circumcircle of any triangle in the triangulation.

“Design of experiments” refers to techniques for identifying points for sampling variables or input parameters to be used in constructing a surrogate modeling system, for example, generating a set of equations that represent the values of parameters at particular points in an uncertainty space. Examples include classical systems and space-filling methods. Specific examples of experimental designs, as would be understood by one of skill in the art, include factorial designs, space-filling designs, full factorial, D-Optimal design, and Latin hypercube designs, among others.

As used herein, “displaying” includes a direct act that causes displaying, as well as any indirect act that facilitates displaying. Indirect acts include providing software to an end user, maintaining a website through which a user is enabled to affect a display, hyperlinking to such a website, or cooperating or partnering with an entity who performs such direct or indirect acts. Thus, a first party may operate alone or in cooperation with a third party vendor to enable the reference signal to be generated on a display device. The display device may include any device suitable for displaying the reference image, such as without limitation a CRT monitor, a LCD monitor, a plasma device, a flat panel device, or printer. The display device may include a device which has been calibrated through the use of any conventional software intended to be used in evaluating, correcting, and/or improving display results (e.g., a color monitor that has been adjusted using monitor calibration software). Rather than (or in addition to) displaying the reference image on a display device, a method, consistent with the techniques, may include providing a reference image to a subject. “Providing a reference image” may include creating or distributing the reference image to the subject by physical, telephonic, or electronic delivery, providing access over a network to the reference, or creating or distributing software to the subject configured to run on the subject's workstation or computer including the reference image. In one example, the providing of the reference image could involve enabling the subject to obtain the reference image in hard copy form via a printer. For example, information, software, and/or instructions could be transmitted (e.g., electronically or physically via a data storage device or hard copy) and/or otherwise made available (e.g., via a network) in order to facilitate the subject using a printer to print a hard copy form of reference image. In such an example, the printer may be a printer which has been calibrated through the use of any conventional software intended to be used in evaluating, correcting, and/or improving printing results (e.g., a color printer that has been adjusted using color correction software).

“Exemplary” is used exclusively herein to mean “serving as an example, instance, or illustration.” Any embodiment described herein as “exemplary” is not necessarily to be construed as preferred or advantageous over other embodiments.

“Flow simulation” is defined as a numerical method of simulating the transport of mass (typically fluids, such as oil, water and gas), energy, and momentum through a physical system using a computer. The physical system includes a three dimensional reservoir model, fluid properties, and the number and locations of wells. Flow simulations also require a strategy (often called a well-management strategy) for controlling injection and production rates. These strategies are typically used to maintain reservoir pressure by replacing produced fluids with injected fluids (for example, water and/or gas). When a flow simulation correctly recreates a past reservoir performance, it is said to be “history matched,” and a higher degree of confidence is placed in its ability to predict the future fluid behavior in the reservoir.

“Formation” means a subsurface region, regardless of size, comprising an aggregation of subsurface sedimentary, metamorphic and/or igneous matter, whether consolidated or unconsolidated, and other subsurface matter, whether in a solid, semi-solid, liquid and/or gaseous state, related to the geologic development of the subsurface region. A formation may contain numerous geologic strata of different ages, textures and mineralogic compositions. A formation can refer to a single set of related geologic strata of a specific rock type or to a whole set of geologic strata of different rock types that contribute to or are encountered in, for example, without limitation, (i) the creation, generation and/or entrapment of hydrocarbons or minerals and (ii) the execution of processes used to extract hydrocarbons or minerals from the subsurface.

“History matching” refers to the process of adjusting unknown parameters of a reservoir model until the model resembles the past production of the reservoir as closely as possible. History matching may be performed by finding a minimum of a function that measures the misfit between actual and simulated data.

“Hydrocarbon management” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

“Injectors” or “injection wells” are wells through which fluids are injected into a formation to enhance the production of hydrocarbons. The injected fluids may include, for example, water, steam, polymers, and hydrocarbons, among others.

“Kriging” is a group of geostatistical techniques to interpolate the value of a random field at an unobserved location from observations of its value at nearby locations. From the geologic point of view, the practice of kriging is based on assuming continuity between measured values. Given an ordered set of measured grades, interpolation by kriging predicts concentrations at unobserved points.

“Local minima” of a function refer to points at which the function value increases in all directions. However, local minima are not necessarily the lowest value for a function that may be found within a parameter space.

“Morse-Smale complex” is a topological data structure that provides an abstract representation of gradient flow behavior of a scalar field. It can be used to approximately find the critical points in a scalar field.

“Multi-dimensional scaling” (MDS) refers to a technique for visualizing differences in data. For example, a set of data indicating distances between any two data points may be reduced to a map of the data points indicating their relative locations in parameter space.

The terms “optimal,” “optimizing,” “optimize,” “optimality,” and “optimization” (as well as derivatives and other forms of those terms and linguistically related words and phrases) are not intended to be limiting in the sense of requiring the present techniques to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present techniques, are more general. The terms can describe working towards a solution which may be the best available solution, a preferred solution, or a solution that offers a specific benefit within a range of constraints; or continually improving; or refining; or searching for a high point or a maximum for an objective; or processing to reduce a penalty function; etc.

“Parameter space” refers to a hypothetical space where a “location” is defined by the values of all parameters. As used herein, the parameter space may be described as a collection of all the parameters, along with the ranges of values that the parameters can take, considered at any stage of history matching, uncertainty or sensitivity analysis, and optimization.

“Permeability” is the capacity of a rock to transmit fluids through the interconnected pore spaces of the rock.

“Porosity” is defined as the ratio of the volume of pore space to the total bulk volume of the material expressed in percent. Porosity is a measure of the reservoir rock's storage capacity for fluids.

“Physics-based model” refers to a predictive model that receives initial data and predicts the behavior of a complex physical system such as a geologic system based on the interaction of known scientific principles on physical objects represented by the initial data.

“Produced fluids” and “production fluids” refer to liquids and/or gases removed from a subsurface formation, including, for example, an organic-rich rock formation. Produced fluids may include both hydrocarbon fluids and non-hydrocarbon fluids. Production fluids may include, but are not limited to, pyrolyzed shale oil, synthesis gas, a pyrolysis product of coal, carbon dioxide, hydrogen sulfide and water (including steam). Produced fluids may include both hydrocarbon fluids and non-hydrocarbon fluids. “Reservoir” or “reservoir formations” are typically pay zones (for example, hydrocarbon producing zones) that include sandstone, limestone, chalk, coal and some types of shale. Pay zones can vary in thickness from less than one foot (0.3048 m) to hundreds of feet (hundreds of m). The permeability of the reservoir formation provides the potential for production.

“Reservoir properties” are defined as quantities representing physical attributes of rocks containing reservoir fluids. The term “reservoir properties” as used in this application includes both measurable and descriptive attributes. Examples of measurable reservoir property values include rock-type fraction (for example, net-to-gross, v-shale, or facies proportion), porosity, permeability, water saturation, acoustic impedance, and fracture density. Examples of descriptive reservoir property values include facies, lithology (for example, sandstone or carbonate), and environment-of-deposition (EOD). Reservoir properties may be populated into a reservoir framework to generate a reservoir model.

“Geologic model” is a computer-based representation of a subsurface earth volume, such as a petroleum reservoir or a depositional basin. Geologic models may take on many different forms. Depending on the context, descriptive or static geologic models built for petroleum applications can be in the form of a 3-D array of cells, to which reservoir properties are assigned. Many geologic models are constrained by stratigraphic or structural surfaces (for example, flooding surfaces, sequence interfaces, fluid contacts, faults) and boundaries (for example, facies changes). These surfaces and boundaries define regions within the model that possibly have different reservoir properties.

“Reservoir model” or “simulation model” refer to a specific mathematical representation of a real hydrocarbon reservoir, which may be considered to be a particular type of geologic model. Simulation models are used to conduct numerical experiments regarding future performance of the field with the goal of determining the most profitable operating strategy. An engineer managing a hydrocarbon reservoir may create many different simulation models, possibly with varying degrees of complexity, in order to quantify the past performance of the reservoir and predict its future performance.

“Saturation” means a fractional volume of pore space occupied by a designated material.

“Scale-up” refers to a process by which a detailed geologic model is converted into a coarser model, for example, by using a fewer number of grid points and by averaging properties of the detailed model. This procedure lowers the computational costs of making a model of a reservoir.

A “surrogate” is an approximation or a substitute to a given physical model such that it provides output similar to the given model at a faster speed. A surrogate can be created by using different methods, such as data regression, machine learning, reduced order modeling, reduced physics modeling, coarsening of model is spatial and time dimensions, and lower order discretization methods.

“Transmissibility” refers to the volumetric flow rate between two points at unit viscosity for a given pressure-drop. Transmissibility is a useful measure of connectivity. Transmissibility between any two compartments in a reservoir (fault blocks or geologic zones), or between the well and the reservoir (or particular geologic zones), or between injectors and producers, can all be useful for understanding connectivity in the reservoir.

“Well” or “wellbore” includes cased, cased and cemented, or open-hole wellbores, and may be any type of well, including, but not limited to, a producing well, an injection well, an experimental well, an exploratory well, and the like. Wells are typically used for accessing subsurface features, such as the hydrocarbon reservoirs discussed herein with respect to hierarchical surrogates.

Exemplary embodiments of the present techniques disclose methods and systems for rapidly evaluating multiple models using multilevel (for example, two or more levels) surrogates. These surrogates form a hierarchy in which surrogate accuracy increases with its level. At the highest level, the surrogate becomes an accurate model, which may be referred to as a full-physics model (FPM). The higher level surrogates may be used to efficiently train the lower level surrogates (more specifically, the lowest level surrogate in most applications), reducing the amount of computing resources used, as discussed further below. The lower level surrogates are then used to evaluate the entire parameter space for various purposes, such as history matching, evaluating the performance of a hydrocarbon reservoir, and the like.

The techniques may be useful for improving hydrocarbon production, for example, by allowing a model of a hydrocarbon reservoir to be developed and used for performance planning or enhancement. Such performance enhancement may, for example, include the determination of locations to drill new wells to a hydrocarbon reservoir. Further, performance enhancement may include changes in the operation of current wells, such as changing injection wells into production wells or production wells into injection wells. Those of ordinary skill in the art will recognize that the present techniques may be applied to many other applications for simplifying the calculations in predictive modeling.

The training of lower level surrogates may be accelerated by performing two core steps between adjacent levels. First, a lower level surrogate may be used to search the parameter space for a training set (TS) in a next higher level surrogate, such as a subset of points in the parameter space at which the higher level surrogate may be trained with responses obtained from a yet higher level surrogate. The higher level surrogate may then be used to train the lower-level surrogate at the TS of the lower level. These steps may occur in sequence, but not necessarily consecutively at the same level. For example, the first step may be recursively performed from the lowest (least accurate) to the highest (most accurate) level before the second step is applied recursively down from the highest (most accurate) to the lowest (least accurate) level.

In exemplary embodiments of the present methods various methods can be used to construct the multilevel surrogate hierarchy. For example, the model equations could be discretized on meshes with different resolutions. In other embodiments, a fine-grid discretization of the model equations could be performed and then multigrid methods, such as algebraic or geometric techniques, could be used to derive coarse-grid discretizations. In reservoir modeling, one can repeatedly scale-up a fine-scale model to coarser scales. The scale-up typically involves solving single-phase steady-state flows, which are much faster than multiphase simulations. Repeated scale-up can be accelerated by using global flow solutions.

Moreover, non-uniform coarsening can be applied to improve the accuracy of the up-scaled models, for example, by coarsening areas which have small changes, and leaving fine details in areas with larger changes (as discussed below). In addition to forming surrogate hierarchies based on different spatial or temporal resolutions, a lower level surrogate may also be prepared by reduced physics or reduced order modeling methods. In reduced physics modeling methods, instead of representing all of the factors that could have an effect on the model response, the strongest controlling factors may be used. For example, in fluid dynamics the viscosity may be neglected for compressible flows having high Reynolds number. Further, in reservoir modeling, capillary pressure, compressibility, and/or gravity can be ignored depending on the properties of the reservoir fluids. In reduced order modeling methods, basis functions whose combinations can represent a range of full-physics responses may be extracted through proper orthogonal decomposition or other machine learning methods. The basis functions may then used to form greatly simplified dynamical systems that mimic the full physics simulations.

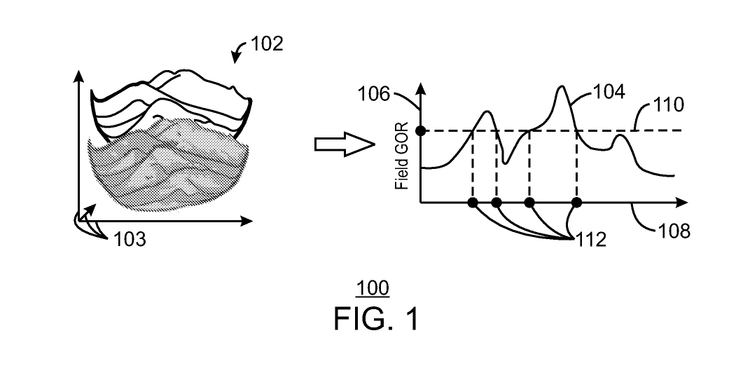

FIG. 1 is a diagram 100 illustrating the use of multiple runs of a set of full physics models (FPM 102) to train a data fit surrogate (DFS 104) for modeling variation of the cumulative field gas-to-oil ratio (at a specified production time, e.g., 30 years) with respect to a model parameter, e.g., the average porosity or permeability of certain a rock type. In the FPMs 102, the axes 103 represent the coordinates of the physical space in which the reservoir models reside. The simulations produce time-dependent fluid movement within the reservoir models as well as in the wells. Each simulation run generates a cumulative field gas-to-oil ratio (GOR) value corresponding to a specific parameter value. In practice, many other measures of reservoir performance are used; the cumulative GOR is used here just as an example.

In the DFS 104, the y-axis 106 may represent the simulated field GOR, while the x-axis 108 may represent the parameter mentioned above. As described above, the DFS 104 may then be used for any number of applications, such as history matching to production data 110, among others, and may yield multiple history matching scenarios 112.

However, using an FPM 102 to generate a training set for the surrogate 104 may require a substantial investment in computing power. More specifically, the entire FPM 102 is typically run for each parameter value (i.e., at each point of axis 108) to train the DFS 104 and, thus, a large number of simulation runs may be needed to provide enough data to obtain an accurate DFS 104. For example, if 100 points are used to train the DFS 104, then the FPM 102 would generally be run at each of the 100 values of the parameter along the x-axis 108. If two parameters are involved, DFS 104 may represent a two-dimensional response surface. Following a similar strategy to create it would require 10,000 simulation runs, which may not be practical.

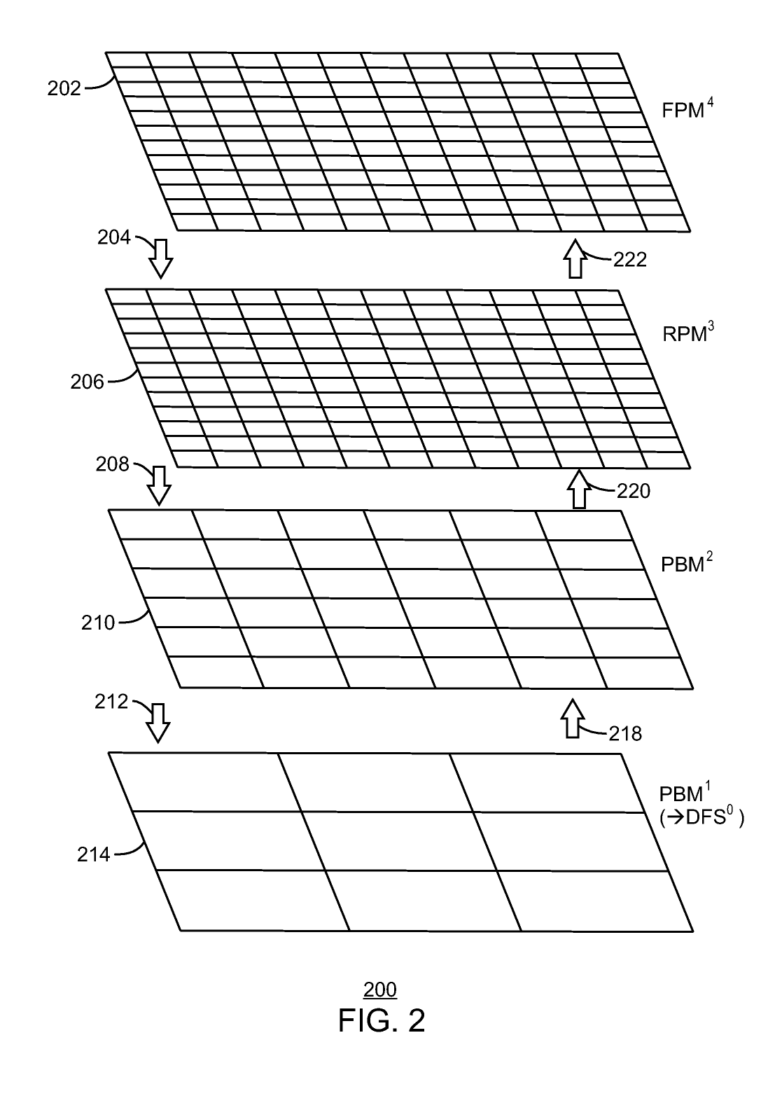

As discussed herein, exemplary embodiments of the present techniques decrease the computing resources used to model a reservoir by creating multiple levels of surrogates, hierarchically ordered to allow training of lower level (less accurate) surrogates by higher level (more accurate) surrogates. The hierarchical surrogates may be generated from the FPM 102 using several techniques. For example, a reduced physics model (RPM) or a coarsened grid may be used to decrease the number of simulations, as discussed above. The use of hierarchical surrogates to decrease the use of computing resources is further explained with respect to FIG. 2.

FIG. 2 is a diagram 200 of a hierarchical group of surrogates 202, 206, 210, and 214 that may be created to more efficiently model a reservoir, in accordance with exemplary embodiments of the present techniques. As described above, each surrogate may represent a spatial discretization of the reservoir on a regular grid. Numerous parameters (such as reservoir and fluid properties) may control the response of the surrogates. As used herein, a superscript denotes models or point sets on a particular level of the hierarchy.

The highest level (most accurate) surrogate is a FPM⁴ 202. In this illustration, the FPM⁴ 202 is constructed on a two-dimensional grid with thirteen divisions along each axis providing, for example, 169 vertices. However, the complexity of the simulation may be reduced (as indicated by arrow 204), for example, by reducing the number of terms used in the equations used for the simulation.

The simplification of the equations may be useful for the generation of a less detailed surrogate, which may be termed a reduced physics model (RPM³ 206). In addition to (or instead of) RPM³ 206, further surrogates may be created by coarsening the grid, for example, using the techniques for discretization discussed above. In this example, the number of vertices can be reduced by half (as indicated by arrow 208) to create a first physics based model (PBM² 210). Further coarsening may be performed to create lower level (in other words, less complex) surrogates. For example, the number of points in the surrogate may be reduced by one half again (as indicated by arrow 212), resulting in a lowest level PBM¹ 214. In comparison to the 169 vertices in the response space of the FPM⁴ 202, the PBM¹ 214 has sixteen. When combined with other surrogates, such as the reduction in the number of terms used to create RPM³ 206, this hierarchy may be used to achieve a significant reduction in the amount of computing resources used.

In an exemplary embodiment of the present techniques, PBM¹ is the first level in the hierarchical surrogates at which simulations are run. For example, PBM¹ 214 may be run at the 100 parameter values (100 points) discussed with respect to FIG. 1 and the responses may then be used to train a continuous mathematical surrogate, called a data fit surrogate) (DFS⁰. The DFS⁰ may be used to select a set of points termed a training set (TS¹) for simulation in higher level surrogates, for example, by identifying critical points in the response surface of DFS⁰. These critical points may include local maxima, local minima, saddle points, or points with high gradients, among others.

The PMB² 210 may then be run for each of the points in TS¹, as indicated by arrow 218. The responses from the simulations may allow the identification of another training set that may be used for training by higher level surrogates. For example, points where the largest difference exist between the responses obtained by running the PBM¹ 214 and the PBM² 210 may be selected as a second training set (TS²). In addition to these points, other points deemed as important may be added to the TS². The RPM³ may then be run at each of the points in TS², as indicated by arrow 220. The FPM⁴ 202 may also be run at each of these points, as indicated by arrow 222. This is equivalent to having a third training set TS³=TS². In other embodiments, TS³ may be selected from the points of TS² in the same way TS² is selected, further reducing the number of full physics simulations that are run.

The responses obtained by running the FPM⁴ 202 at each of the points of TS³ may then be used to train the RPM³ 206, increasing the accuracy of the surrogate. After the RPM³ 206 is trained, the trained RPM³ 206 may then be run at each of the points from TS², and the responses obtained from running the RPM³ 206 at each of these points may be used to train PBM² 210. The PBM² 210 may then be run at each of the points in TS¹, and the responses used to train PBM¹ 214. Training may be performed, for example, by adjusting or tuning equation coefficients used in the surrogate until the responses obtained from the surrogate match those obtained from a higher level surrogate. The responses obtained by running the trained PBM¹ 214 at each of the points in TS¹ and additional points may then be used to train the DFS⁰, for example, by fitting a mathematical function to the responses. The procedure described above may result in an accurate mathematical surrogate using fewer computing resources than using the full physics model to train the DFS⁰ directly.

The present techniques are not limited to the hierarchical arrangement of surrogates presented above. In exemplary embodiments, any number of lower level surrogates may be created from higher level surrogates by any number of techniques, including combinations of reduced physics models, physics based models containing fewer degrees of freedom, and data fit surrogates. Further any number of resolutions may used in the coarsened grid. In some embodiments, the RPM³ 206 may be directly used to train the DFS⁰, while in other embodiments, no RPM may be included in the hierarchy.

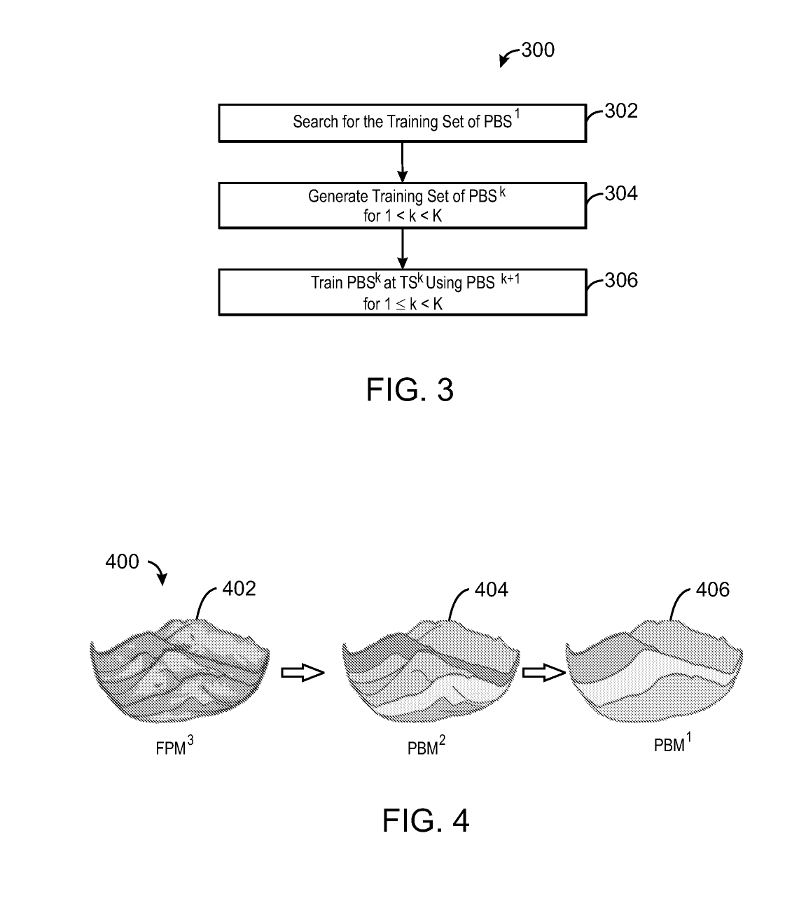

FIG. 3 is a block diagram of a method 300 for using hierarchical surrogates in accordance with embodiments of the present techniques. For each point in the parameter space, multilevel (less accurate) surrogates can be constructed for the FPM corresponding to that point. In exemplary embodiments, the construction may be performed by using different spatial and temporal resolutions to approximate the FPM. In other embodiments, RPMs may be constructed from the FPM, as discussed herein. The PBMs can be distinguished from DFSs in the procedures below. In general, the DFSs require extensive training by PBMs in order to be useful and they may not be used in the surrogate hierarchy. If they are used in the hierarchy, DFSs are typically at the lowest level. In contrast, a PBM may produce a response at every point in the parameter space without training However, in exemplary embodiments, training of the PBMs may be used to improve their accuracy. The lowest level PBM is termed “PBM¹.” According to the above discussion, if DFS is used in the hierarchy, it will be DFS⁰. The highest level is denoted as K. Thus, PBM^{K} is the FPM which requires no training

The method 300 begins at block 302 with searching for a training set for PBM¹. This is performed by sampling the parameter space and obtaining a set of sample points. Numerous different sampling strategies can be used, such as random sampling using a Latin Hypercube method or structured sampling on regular or sparse grids. The model responses are evaluated using the lowest level PBM¹ at the sample points.

In an exemplary embodiment, a DFS⁰ is constructed (trained) over the parameter space using the sample points and corresponding responses. A variety of machine learning methods can be used to construct the DFS⁰. If the sampling has been performed on a sparse grid, then interpolation methods on the sparse grid can be used. Further, adjoint methods, which are commonly used in derivative-based optimizations, can be combined with PBM¹ to calculate derivatives at the sample points. Including the derivatives in the construction of the DFS⁰ may improve the accuracy of the DFS⁰.

From the DFS⁰, a training set (TS¹) is built by selecting points where the DFS⁰ exhibits some “critical” behavior, for example, reaching a local maximum or a saddle point, among others. In exemplary embodiments, the critical points can be approximately determined by using optimization methods. For example, a search for local maxima or saddle points may be performed from each of the sample points. Since the purpose of the search is to find approximations to local critical points for training purpose, the search for critical points does not need to be detailed, for example, stopping when the response changes by less than 1%, 5%, 10%, or more. In other exemplary embodiments, a subset of the sample points may be chosen as starting points for a search. For random sample points, Delaunay triangulation in high dimensional space can be used to determine connectivity among sample points and allow discrete search of critical points.

For identifying critical points sampling on regular or sparse grid may be beneficial, but is not necessary. It should be understood that any number of other definitions of the critical points may be used and, further, that not all local maxima or saddle points may be identified in the search. For example, a useful search could be based on discrete Morse-Smale complexes, which can be used to detect critical points of the topology of the response space at different scales.

After a training set for PBM¹ is identified, at block 304, training sets for PBM^{k}, wherein 1<k<K, may be generated. This may be performed recursively from lower to higher levels. To identify the higher level training sets, PBM^{k} is evaluated at points in TS^{k-1}. All points in TS^{k-1} may be used or a subset may be selected. For example, a subset of TS^{k-1} may be selected where the difference between the responses from PBM^{k} and PBM^{k-1} are relatively large (for example, 5%, 10%, 20%, or even greater than the average differences in the responses). This subset may be termed TS^{k}. In an exemplary embodiment, one can construct DFS^{k} and compare it with DFS^{k-1} over the parameter space. This comparison can be used to determine additional points to compare PBM^{k} and PBM^{k-1}. Thus, a subset of those points can then be added to TS^{k} and TS^{k-1}, and, optionally, TS at lower levels. In other embodiments, different measures can be used to select the additional points. For example, a likelihood function (DFS^{k}|DFS^{k-1}) may be used. This technique can be very useful at lower (less accurate) levels of the surrogate hierarchy. In an exemplary embodiment, the process of determining training points for PBM^{k} may be iterated to improve the accuracy. For example, when new training points are determined, they will be used to recalibrate DFS^{k} and DFS^{k-1}, which can be used again to determine additional points.

After the training sets are generated, at block 306, PBM^{k} is trained at TS^{k} using PBM^{k+1} for 1≦k≦K. The training is recursive and top-down, in other words, it starts from k=K−1 and moves down one level at a time. Various methods may be used to train PBM^{k} in exemplary embodiments. For example, in one exemplary embodiment, if PBM^{k} has parameters that are estimated and can be tuned to match the desired model response, then training may be considered to be parameter estimation of PBM^{k} given the responses of PBM^{k+1} at TS^{k}. This method has the benefit that the trained PBM^{k} can be used to predict other model responses not used in training In other embodiments, the differences between PBM^{k} and PBM^{k+1} at TS^{k} are modeled through a DFS. Thus, no parameter in PBM^{k} needs to be adjusted. However, the DFS is associated with a specific model response. This technique may be more effective when TS^{k} has sufficient coverage of the parameter space and the difference between the two surrogates is a relatively smooth function. Furthermore, the training techniques may be used individually or in combinations, for example, at different levels of the hierarchy. The bottom-up and then top-down iterations discussed with respect to blocks 302, 304, and 306 may be termed a single A-cycle.

In exemplary embodiments, the basic A-cycle is used as a building block for more complex iterative procedures. For example, the A-cycle may be repeated several times until convergence is reached. Convergence indicates that further training no longer alters the model response at the lowest level (such as less than about 1%, 5%, 10%, or higher, change between iterations). For example, one complex iterative procedure that may be used in an exemplary embodiment includes defining a Aₘ-cycle as a A-cycle in which K in blocks 304 and 306 is replaced by some m≦K. Thus, the original A-cycle becomes a A_{K}-cycle. Using this definition, the iterative procedure involves performing the Aₘ-cycle with increasing m, where 1<m≦K. This iteration is called a full cycle. As discussed above, the full cycle may be repeated until convergence is reached. Other complex iterative procedures may be used in embodiments of the present techniques.

In exemplary embodiments, the method 300 can be adapted to provide efficient training with constraints. Constraints on model responses are common in parameter identification and optimization problems. The constraints may either come from prior knowledge about the model response or from input during interactive learning. For example, an additional step may be added to the training algorithm discussed with respect to block 306 to evaluate if constraints on the model are satisfied during the search for critical points or uncertain regions. This additional step can also be performed before the training starts as a pre-processing step, for example, if the parameter space is screened, regions that do not satisfy the constraints may be removed. To efficiently check the constraints, surrogates may be added to the multilevel hierarchy. For example, in reservoir modeling, graph-based methods, such as the shortest-path or fast marching algorithms, may be added for measuring reservoir connectivity either based on static permeability distributions or single-phase or multi-phase flow solutions. Other reduced-physics modeling techniques can also be used.

The training cycles described above may work efficiently when the surrogate hierarchy is constructed through recursive coarsening of a full physics model in space and time dimensions. The coarsening may be adaptive as to preserve the elements of a more detailed model. This may decrease abrupt changes from one level to another. To this end, methods using reduced physics models can detect the features for preservation. Furthermore, the recursive coarsening of fine resolution model may be nested, in the sense that coarse grid cells are combinations of fine grid cells. This may simplify the mapping between coarse and fine grids, facilitating the comparison of model responses.

### EXAMPLE

For purposes of the example presented with respect to FIGS. 4-10, the direct training of the DFS 104 from the FPM 102, discussed with respect to FIG. 1, is assumed to require 100 runs of the FPM 102. FIG. 4 is a diagram 400 illustrating coarsening to create two hierarchical levels of PBMs from a FPM, in accordance with exemplary embodiments of the present techniques. As illustrated in this diagram, the highest (most accurate) level of simulation is the full physics model (FPM³) 402. In this example, the FPM³ corresponds to the FPM 102 of FIG. 1. A lower hierarchical level, PBM² 404, may be generated by either lowering the number of points on the mesh, by reducing the number of parameters used in the calculation to generate a RPM, or both. In this example, the PBM² 404 is assumed to require one tenth of the computing resources of the FPM³ 402. Generating the PBM² 404 is not limited to a top down case. In exemplary embodiments, the elimination of points from the model may not occur until the lowest level surrogate is run.

The lowest level physics based surrogate, termed PBM¹ 406, may be generated by coarsening the next higher level surrogate, PBM² 404, using the same techniques as discussed above. In this example, the PBM¹ 406 is assumed to require one tenth of the computing resources of the PBM² 404, or one one-hundredth of the computing resources of the FPM³ 402. As for the generation of PBM¹ 406, the generation of PBM² 404 may be performed by creating evenly spaced points at some multiple of the points in PBM¹ 406. The generation of the surrogates may be performed by the techniques discussed with respect to FIGS. 2 and 3.

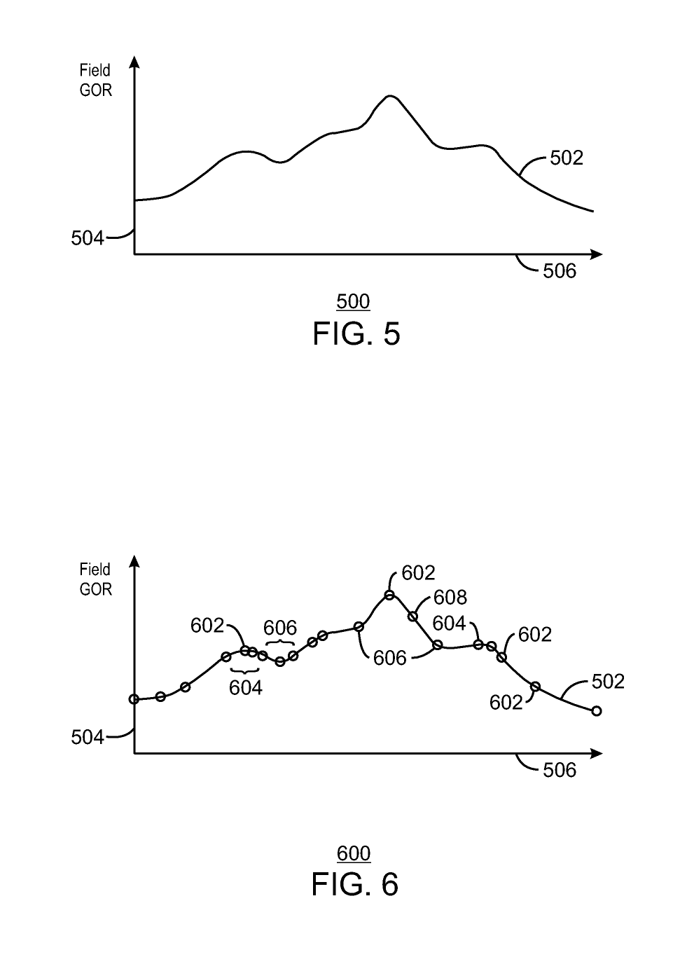

FIG. 5 is a graph 500 of a data fit surrogate (DFS⁰ 502) trained from PBM¹ 406, in accordance with embodiments of the present techniques. In the graph 500, the y-axis 504 represents a relative measure of gas-to-oil ratio (GOR) over a field. The x-axis 506 represents a controlling parameter for GOR, such as porosity or permeability. Referring also to FIG. 4, the DFS⁰ 502 may be trained by using 100 points that are evenly spaced across the DFS⁰ 502, for example, using responses obtained by running a simulation of PBM¹ 406 at each of the points. In terms of computing power, 100 runs of PBM¹ 406 would represent one run of the FPM³ 402. Critical points in the DFS⁰ 502 may be selected for further exploration to ensure that the performance is accurately modeled. For example, the critical points may be points at which the DFS⁰ 502 exhibits local maxima, saddle points, or large slopes, as discussed further with respect to FIG. 6. These points may be considered to be a first training set TS¹.

FIG. 6 is a graph 600 illustrating the response of twenty sample points (TS¹ 602) selected from the DFS⁰ 502 for further modeling in accordance with embodiments of the present techniques. As previously mentioned, TS¹ 602 may be clustered at critical points in DFS⁰ 502, such as local maxima 604, saddle points 606, and high slope points 608, among others. The next higher (more accurate) level of simulation, for example, PBM² 404 (FIG. 4), may then be run at these points. In terms of computing power, the 20 simulation runs of TS¹ 602 in PBM² 404 correspond to two runs of the FPM³ 402.

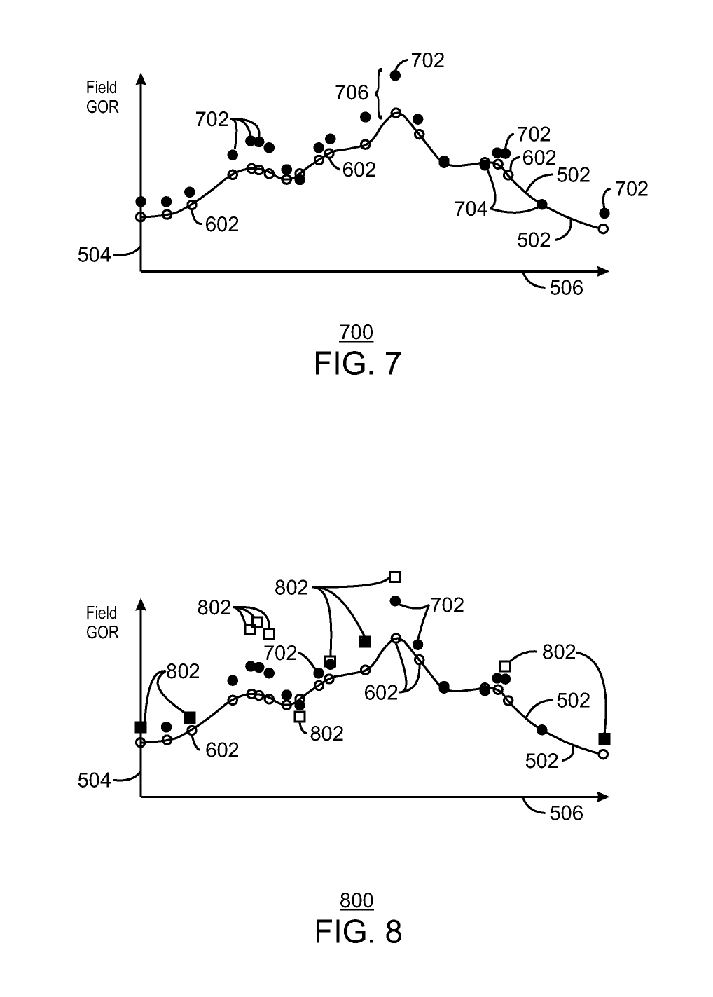

FIG. 7 is a graph 700 illustrating the responses 702 from PBM² 404 for the points in TS¹ 602, in accordance with embodiments of the present techniques. Although the responses 702 may come close or match the selected points in some circumstances (as indicated by reference number 704), in many cases there may be a substantial difference between the responses of PBM² 404 and PBM¹ 406 (as indicated by reference number 706). Thus, to improve the accuracy of the surrogate, the highest level simulation, FPM³ 402, may be run at the points having the largest differences. In this example, the FPM³ 402 was run at eleven selected points, which may be termed TS².

FIG. 8 is a graph 800 illustrating the responses at the eleven points of TS² 802 in FPM³ 402, in accordance with embodiments of the present techniques. As can be seen in FIG. 8, the responses for the eleven points of TS² 802 showed differences from the responses for TS¹ 602 for the twenty selected points and the responses 702 from PBM² 404. The responses for the eleven points of TS² 802 at which the FPM³ 402 were run were then used to train PBM² 404. After the training, the remaining nine points of TS¹ 602 were run using the trained PBM² 404.

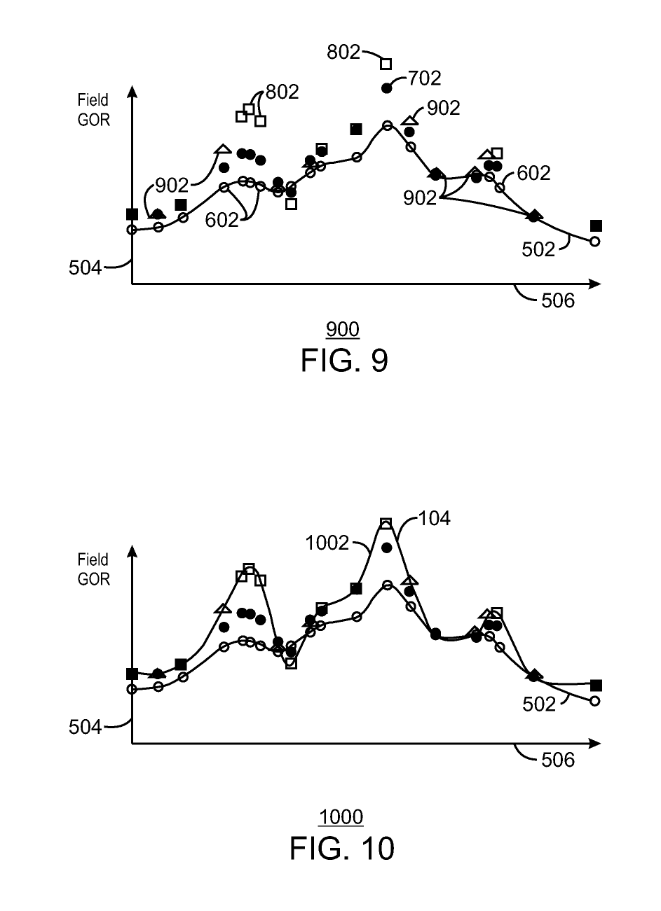

FIG. 9 is a graph 900 illustrating the responses 902 obtained from PBM² 404 at the remaining nine points of TS¹ 602 run after training of PBM² 404 by the responses from TS² 802 obtained from the FPM³ 402, in accordance with embodiments of the present techniques. The 20 responses from TS² 802 and the remaining responses 902 may then be used to train PBM¹ 406, which may then be used to train the DFS⁰ 502.

FIG. 10 is a graph 1000 of the final DFS⁰ 1002 constructed after the 20 responses from TS² 802 and the remaining responses 902 are used to train the PBM¹ 406, in accordance with embodiments of the present techniques. As can be seen in this graph 1000, the response of the final DFS⁰ 1002 closely matches the DFS 104 (FIG. 1) generated from 100 runs of the FPM 102. However, the DFS⁰ 1002 was generated using an amount of computing power corresponding to only 15 runs of the FPM 102 versus 100 runs of the FPM 102 used to generate the DFS 104 discussed with respect to FIG. 1.

### Systems

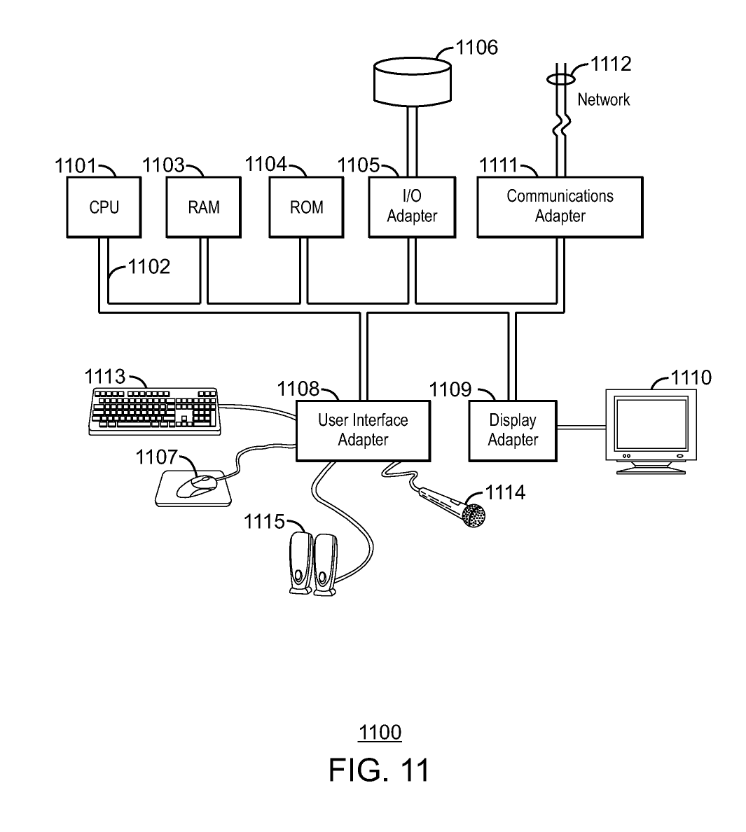

The techniques discussed herein may be implemented on a computing device, such as that illustrated in FIG. 11. FIG. 11 illustrates an exemplary computer system 1100 on which software for performing processing operations of embodiments of the present techniques may be implemented. A central processing unit (CPU) 1101 is coupled to a system bus 1102. In embodiments, the CPU 1101 may be any general-purpose CPU. The present techniques are not restricted by the architecture of CPU 1101 (or other components of exemplary system 1100) as long as the CPU 1101 (and other components of system 1100) supports the inventive operations as described herein. The CPU 1101 may execute the various logical instructions according to embodiments. For example, the CPU 1101 may execute machine-level instructions for performing processing according to the exemplary operational flow described above in conjunction with FIG. 3. As a specific example, the CPU 1101 may execute machine-level instructions for performing the methods of FIG. 3.

The computer system 1100 may also include random access memory (RAM) 1103, which may be SRAM, DRAM, SDRAM, or the like. The computer system 1100 may include read-only memory (ROM) 1104 which may be PROM, EPROM, EEPROM, or the like. The RAM 1103 and the ROM 1104 hold user and system data and programs, as is well known in the art.

The computer system 1100 may also include an input/output (I/O) adapter 1105, a communications adapter 1111, a user interface adapter 1108, and a display adapter 1109. The I/O adapter 1105, user interface adapter 1108, and/or communications adapter 1111 may, in certain embodiments, enable a user to interact with computer system 1100 in order to input information.

The I/O adapter 1105 connects to storage device(s) 1106, such as one or more of hard drive, compact disc (CD) drive, floppy disk drive, tape drive, flash drives, USB connected storage, etc. to computer system 1100. The storage devices may be utilized when RAM 1103 is insufficient for the memory requirements associated with storing data for operations of embodiments of the present techniques. The data storage of computer system 1100 may be used for storing such information as angle stacks, AVA attributes, intermediate results, and combined data sets, and/or other data used or generated in accordance with embodiments of the present techniques. The communications adapter 1111 is adapted to couple the computer system 1100 to a network 1112, which may enable information to be input to and/or output from the system 1100 via the network 1112, e.g., the Internet or other wide-area network, a local-area network, a public or private switched telephony network, a wireless network, or any combination of the foregoing. The user interface adapter 1108 couples user input devices, such as a keyboard 1113, a pointing device 1107, and a microphone 1114 and/or output devices, such as speaker(s) 1115 to computer system 1100. The display adapter 1109 is driven by the CPU 1101 to control the display on the display device 1110, for example, to display information pertaining to a target area under analysis, such as displaying a generated 3D representation of the target area, according to certain embodiments.

It shall be appreciated that the present techniques are not limited to the architecture of the computer system 1100 illustrated in FIG. 11. For example, any suitable processor-based device may be utilized for implementing all or a portion of embodiments of the present techniques, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

While the present techniques may be susceptible to various modifications and alternative forms, the exemplary embodiments discussed above have been shown only by way of example. However, it should again be understood that the present techniques are not intended to be limited to the particular embodiments disclosed herein. Indeed, the present techniques include all alternatives, modifications, and equivalents falling within the true spirit and scope of the appended claims.

1. A method for lowering computational costs of multiple simulations, comprising:
identifying a lowest level training set (TS¹) in a lowest level physics based surrogate (PBM¹);
generating at least one higher level training set (TS^{k}) for at least one higher level PBM^{k}, wherein 1<k<K, and wherein K represents a highest level; and
training the at least one higher level PBM^{k} at TS^{k} using a next higher level physics based surrogate (PBM^{k+1}).

2. The method of claim 1, wherein identifying TS¹ comprises:
sampling a parameter space to obtain a first set of sample points;
evaluating a response for PBM¹ at each of the sample points;
training a data fit surrogate (DFS⁰) over the parameter space using the response at each of the sample points; and
identifying a second set of sample points as TS¹, wherein a response of the DFS⁰ exhibits a critical behavior at the sample points.

3. The method of claim 2, wherein the critical behavior corresponds to a local maximum, a local minimum, a saddle point, a high gradient point, or a combination thereof.

4. The method of claim 1, wherein generating the TS^{k} for the PBM^{k} comprises:
evaluating PBM^{k} at lower level sample points in TS^{k-1}; and
selecting a subset of the sample points at which the difference between a response of PBM^{k} and PBM^{k-1} is relatively large, wherein the subset comprises TS^{k}.

5. The method of claim 4, wherein generating the TS^{k} for the PBM^{k} comprises:
adding additional sample points to TS^{k} based at least in part on an estimate of the distribution of the difference between PBM^{k} and PBM^{k-1} over the parameter space.

6. The method of claim 1, wherein at least one of the PBM^{k} is a reduced physics model (RPM).

7. The method of claim 1, wherein training the at least one higher level PBM^{k} comprises:
estimating parameters of PBM^{k} given responses of PBM^{k+1} at TS^{k}; and
tuning the coefficients to match the responses.

8. The method of claim 1, wherein training the at least one higher level PBM^{k} comprises:
modeling the differences between PBM^{k} and PBM⁺¹ at TS^{k} using a DFS.

9. The method of claim 1, further comprising:
repeating an iteration comprising:
identifying a lowest level training set (TS¹) in a lowest level physics based surrogate (PBM¹);
generating at least one higher level training set (TS^{k}) for at least one higher level PBM^{k}, wherein 1<k<K; and
training the at least one higher level PBM^{k} at TS^{k} using a next higher level physics based surrogate (PBM^{k+1}).

10. The method of claim 9, further comprising:
repeating the iteration until a model response at the lowest level changes by less than about 5% between iterations.

11. The method of claim 1, further comprising:
coarsening a full physics model by discretizing model equations on meshes with different resolutions.

12. The method of claim 1, further comprising:
performing a fine-grid discretization of model equations; and
performing a mathematical multigrid operation to derive a coarse-grid discretization of the model equations.

13. The method of claim 1, further comprising:
coarsening a fine-scale reservoir model to a coarse scale reservoir model by solving a series of single-phase steady-state flow equations.

14. A method for producing hydrocarbons, comprising:
generating a model based on hierarchical surrogates, comprising:
identifying a lowest level training set (TS¹) in a lowest level physics based surrogate (PBM¹);
generating at least one higher level training set (TS^{k}) for at least one higher level PBM^{k}, wherein 1<k<K, and wherein K represents a highest level surrogate; and
training the at least one higher level PBM^{k} at TS^{k} using a next higher level physics based surrogate (PBM^{k+1}); and
predicting a performance parameter from the model.

15. The method of claim 14, further comprising:
determining a location for a new well based at least in part on the predicted performance parameter.

16. The method of claim 14, further comprising:
converting an injection well into a production well, a production well into an injection well, or both based at least in part upon the performance parameter predicted from the model.

17. A tangible, machine-readable medium, comprising code configured to direct a processor to:
identify a lowest level training set (TS¹) in a lowest level physics based surrogate (PBM¹);
generate at least one higher level training set (TS^{k}) for at least one higher level PBM^{k}, wherein 1<k<K; and
train the at least one higher level PBM^{k} at TS^{k} using a next higher level physics based surrogate (PBM^{k+1}).

18. The tangible, machine-readable medium of claim 17, comprising code configured to direct the processor to:
sample a parameter space to obtain a first set of sample points;
evaluate a response for PBM¹ at each of the sample points;
train a data fit surrogate (DFS⁰) over the parameter space using the response at each of the sample points; and
identify a second set of sample points for the TS¹, wherein a response of the DFS⁰ exhibits a critical behavior at the second set of sample points.

19. The tangible, machine-readable medium of claim 17, comprising code configured to direct the processor to:
evaluate PBM^{k} at lower level sample points in TS^{k-1}; and
select a subset of the lower level sample points at which the difference between a response of PBM^{k} and PBM^{k-1} is relatively large, wherein the subset comprises TS^{k}.

20. The tangible, machine-readable medium of claim 17, comprising code configured to direct the processor to:
estimate parameters of PBM^{k} from responses of PBM^{k+1} at TS^{k}; and
tune the parameters to match the responses.
